(19) United States
(12) Patent Application Publication
(10) Pub. No.: US 2007/0019070 A1
(43) Pub. Date: Jan. 25, 2007

(54) Method of forming optical images, an array of converging elements and an array of light valves for use in this method, apparatus for carrying out this method and a process for manufacturing a device using this method

(75) Inventors: Johannes Hubertus Antonius Van De Rijdt, Eindhoven (NL); Roger Anton Marie Timmermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/569,184

(22) PCT Filed: Aug. 9, 2004
(86) PCT No.: PCT/IB04/51423

§ 371 Date: Feb. 22, 2006

(30) Foreign Application Priority Data
Aug. 27, 2003 (EP) 03103226.1

(51) Int. Cl. H04N 5/253

(52) U.S. Cl. 348/97

(57) ABSTRACT

A maskless lithography method and apparatus, whereby corresponding sets of light valves (7) and radiation-converging elements (17) are provided between a radiation source and a radiation-sensitive layer (3). Each converging element corresponds to a different one of the light valves (7) and serves to converge radiation from the corresponding light valve (7) in a spot area in the radiation-sensitive layer (3). Each light valve (7) can be switched between an on and off state in dependence upon the image to be written in the radiation-sensitive layer (3) by the light valve (7). The light converging elements (17) are provided in a single, unitary optical element, and arranged in a single row substantially equal to or greater than the width or length of the radiation-sensitive layer (3).

Method of forming optical images, an array of converging elements and an array of light valves for use in this method, apparatus for carrying out this method and a process for manufacturing a device using this method

The invention relates to a method of forming an optical image in a radiation-sensitive layer, the method comprising the steps of:
providing a radiation source;
providing a radiation-sensitive layer;
positioning a plurality of individually controlled light valves between the radiation source and the radiation-sensitive layer;
positioning a plurality of radiation-converging elements between the plurality of light valves and the radiation-sensitive layer, such that each converging element corresponds to a different one of the light valves and serves to converge radiation from the corresponding light valve in a spot area in the radiation-sensitive layer; and
simultaneously writing image portions in radiation-sensitive layer areas by scanning said layer, on the one hand, and the associated light valve/converging element pairs, on the other hand, relative to each other and switching each light valve between an on and off state in dependence upon the image portion to be written by the light valve.

The invention also relates to an apparatus for carrying out this method, an array of light converging elements and an array of light valves for use in this method, and a method of manufacturing a device using this method.

A plurality of light valves, or optical shutters, is understood to mean a plurality of controllable elements, which can be switched between two states. In one of the states, radiation incident on such an element is blocked and in the other state the incident radiation is transmitted or reflected to follow a path which is prescribed in the apparatus of which the elements form part.

The plurality of light valves may be provided by a transmissive or reflective liquid crystal display (LCD) or a digital mirror device (DMD). The radiation sensitive layer is, for example, a resist layer used optical lithography, or an electrostatically charged layer used in a printing apparatus.

This method and apparatus may be used, inter alia, in the manufacture of devices such as liquid crystal display (LCD) panels, customized-IC's (integrated circuits) and PCB's (printed circuit boards). Currently, proximity printing is used in the manufacture of such devices. Proximity printing is a fast and cheap method of forming an image in a radiation-sensitive layer on a substrate of the device, which image comprises features corresponding to device features to be configured in a layer of the substrate. Use is made of a large photomask that is arranged at a short distance, called the proximity gap, from the substrate, and the substrate is illuminated via the photomask by, for example, ultraviolet (UV) radiation. An important advantage of the method is the large image field, so that large device patterns can be imaged in one image step. The pattern of a conventional photomask for proximity printing is a true, one-to-one copy, of the image required on the substrate, i.e. each picture element (pixel) of this image is identical to the corresponding pixel in the mask pattern.

Proximity printing has a limited resolution, i.e. the ability to reproduce features (such as points, lines, etc.) of the mask pattern as separate entities in the sensitive layer on the substrate. This is due to the diffractive effects, which occur when the dimensions of the features decrease with respect to the wavelength of the radiation used for imaging. For example, for a wavelength in the near UV range and a proximity gap width of 100 μm, the resolution is 10 μm, which means that pattern features at a mutual distance of 10 μm can be imaged as separate elements.

To increase the resolution in optical lithography, a real projection apparatus is used, i.e. an apparatus having a real projection system like a lens projection system or a mirror projection system. Examples of such apparatus are wafer steppers or wafer step-and-scanners. In a wafer stepper, a whole mask pattern, for example an IC pattern, is imaged in one go by a projection lens system on a first IC area of the substrate. Then the mask and substrate are moved (stepped) relative to each other until a second IC area is positioned below the projection lens. The mask pattern is then imaged on the second IC area. These steps are repeated until all IC areas of the substrate are provided with an image of the mask pattern. This is a time-consuming process, due to the sub-steps of moving, aligning and illumination. In a step-and-scanner, only a small portion of the mask pattern is illuminated at once. During illumination, the mask and the substrate are synchronously moved with respect to the illumination beam until the whole mask pattern has been illuminated and a complete image of this pattern has been formed on an IC area of the substrate. Then the mask and substrate are moved relative to each other until the next IC area is positioned under the projection lens and the mask pattern is again scan-illuminated, so that a complete image of the mask pattern is formed on the next IC area. These steps are repeated until all IC areas of the substrate are provided with a complete image of the mask pattern. The step-and-scanning process is even more time-consuming than the stepping process.

If a 1:1 stepper, i.e. a stepper with a magnification of one, is used to print an LCD pattern, a resolution of 3 μm can be obtained, however, at the expense of much time for imaging. Moreover, if the pattern is large and has to be divided into sub-patterns, which are imaged separately, stitching problems may occur, which means that neighbouring sub-fields do not exactly fit together.

The manufacture of a photomask is a time-consuming and cumbersome process, which renders such a mask expensive. If much re-design of a photomask is necessary or in the case of a customer-specific device, whereby a relatively small number of the same device are required to be manufactured, the lithographic manufacturing method using a photomask is an expensive option.

The paper: “Lithographic Patterning and Confocal Imaging with Zone Plates” by D. Gil et al in: J. Vac. Sci. Technology B 18(6), November/December 2000, pages 2881-2885, describes a lithographic method wherein, instead of a photomask, a combination of a DMD array and an array of zone plates is used. If the array of zone plates, also called Fresnel lenses, is illuminated, it produces an array of radiation spots, in the experiment described in the paper: and array of 3×3 X-ray spots, on a substrate. The spot size is approximately equal to the minimum feature size, i.e. the outer zone width, of the zone plate. The radiation to each zone plate is separately turned on and off by the micromechanic means of the DMD device, and arbitrary patterns can be written by raster scanning the substrate through a zone plate unit cell. In this way, the advantages of maskless lithography are combined with a high throughput due to parallel writing with an array of spots.

We have now devised an improved arrangement, which provides an accurate and radiation-efficient lithographic imaging method and apparatus.

In accordance with the present invention, there is provided a method of forming an optical image in a radiation-sensitive layer, the method comprising the steps of:
providing a radiation source;
providing a radiation-sensitive layer;
positioning a plurality of individually controlled light valves between the radiation source and the radiation-sensitive layer;
positioning a plurality of radiation-converging elements between the plurality of light valves and the radiation-sensitive layer, such that each converging element corresponds to a different one of the light valves and serves to converge radiation from the corresponding light valve in a spot area in the radiation-sensitive layer; and
simultaneously writing image portions in radiation-sensitive layer areas by scanning said layer, on the one hand, and the associated light valve/converging element pairs, on the other hand, relative to each other and switching each light valve between an on and off state in dependence upon the image portion to be written by the light valve;
the method being characterized in that:
   the radiation-converging elements are arranged in side-by-side relation in a single row of length substantially equal to or greater than the width or length of the radiation-sensitive layer.

The plurality of radiation-converging elements is beneficially used in the form of a single, unitary optical element, separate from the plurality of light valves.

Also in accordance with the present invention, there is provided apparatus for carrying out this method, the apparatus comprising:
a radiation source;
a radiation-sensitive layer;
a plurality of individually controlled light valves positioned between the radiation source and the radiation-sensitive layer;
a plurality of radiation-converging elements positioned between the plurality of light valves and the radiation-sensitive layer, such that each converging element corresponds to a different one of the light valves and serves to converge radiation from the corresponding light valve in a spot area in the radiation-sensitive layer; and
means for simultaneously writing image portions in radiation-sensitive layer areas by scanning said layer, on the one hand, and the associated light valve/converging element pairs, on the other hand, relative to each other and switching each light valve between an on and off state in dependence upon the image portion to be written by the light valve; the apparatus being characterized in that:
   the radiation-converging elements are arranged in side-by-side relation in a single row of length substantially equal to, or greater than, the width or length of the radiation-sensitive layer.

Still further in accordance with the present invention, there is provided an optical element comprising a plurality of radiation-converging elements, for use in a method of forming an optical image in a radiation-sensitive layer as defined above, the radiation converging elements being arranged in side-by-side relation in a single row substantially equal to or greater than the width or length of the radiation-sensitive layer.

Still further in accordance with the present invention, there is provided an image forming element, comprising a plurality of individually controlled light valves, for use in a method of forming an optical image in a radiation-sensitive layer as defined above, the light valves being arranged in side-by-side relation in a single row of length substantially equal to or greater than the width or length of the radiation-sensitive layer.

Still further in accordance with the present invention, there is provided a method of manufacturing a device in at least one process layer of a substrate, the method comprising the steps of:
forming an image in a resist layer provided on the process layer, the image comprising features corresponding to the device features to be configured in the process layer; and
removing material from, or adding material to, areas of the process layer, which areas are delineated by the image formed in the resist layer, characterized in that the image is formed by means of the method as defined above.

In a preferred embodiment, said radiation-sensitive layer and said light valve/converging elements are scanned relative to each other in a direction substantially perpendicular to the row of converging elements.

The converging elements may comprise refractive or diffractive lenses, to create a row or array of spots in the radiation-sensitive layer. Beneficially, between successive sub-illuminations, the radiation-sensitive layer and the arrays are displaced relative to each other over a distance which is at most equal to the size of the spots formed in the radiation-sensitive layer.

The intensity of a spot at the border of an image feature may be adapted to the distance between this border feature and a neighbouring feature.

The row of light valves may be positioned directly to face the row of converging elements, or the row of light valves may be imaged on the row of converging elements.

In a preferred embodiment, the row of converging elements is preferably provided for use as a unitary optical element, which may comprise a unitary structure having all of the converging elements provided therein, or it may comprise a support means on which each separate converging element may be mounted, so as to form a unitary element for use.

The method may form part of a lithographic process for producing a device in a substrate, in which case, the radiation-sensitive layer is preferably a resist layer provided on a substrate, and the image pattern preferably corresponds to the pattern of features of the device to be produced. In this case, the image is preferably divided into sub-images, each belonging to a different level of the device to be produced, and during formation of the different sub-images, the resist layer surface is preferably set at different distances from the row of radiation converging elements. Alternatively, the method may form part of a process for printing a sheet of paper, in which case the radiation-sensitive layer is preferably a layer of electrostatically charged material.

These and other features of the invention will be apparent from, and elucidated with reference to, the embodiment described hereinafter.

An embodiment of the present invention will now be described by way of example only and with reference to the accompanying drawings, in which:

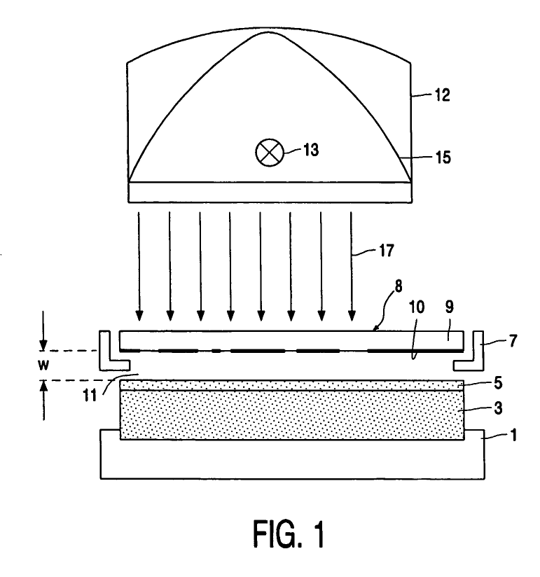

FIG. 1 is a schematic diagram of a conventional proximity printing apparatus;

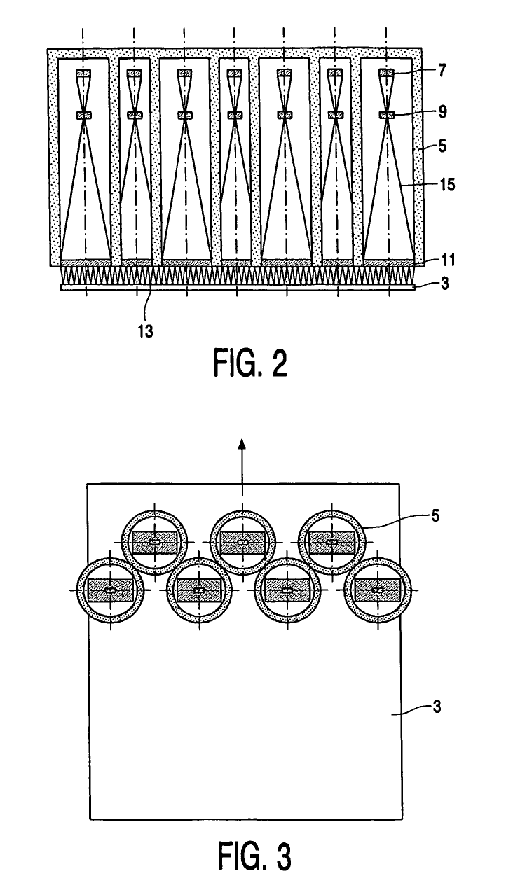

FIG. 2 is a schematic cross-sectional view of a maskless lithography system according to the prior art;

FIG. 3 is a schematic plan view of the maskless lithography system of FIG. 2;

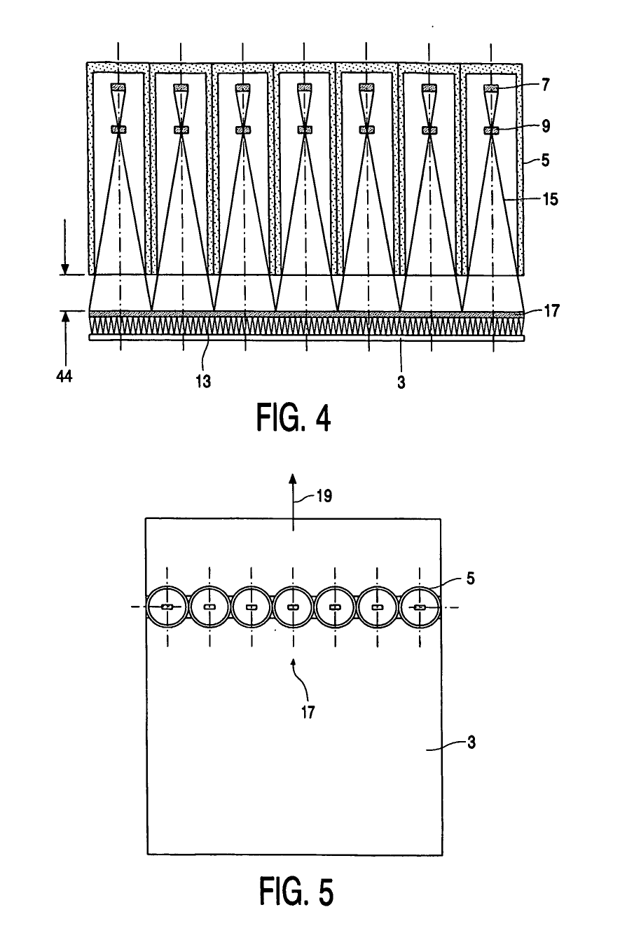

FIG. 4 is a schematic cross-sectional view of a maskless lithography system according to an exemplary embodiment of the present invention;

FIG. 5 is a schematic plan view of the maskless lithography system of FIG. 4; and

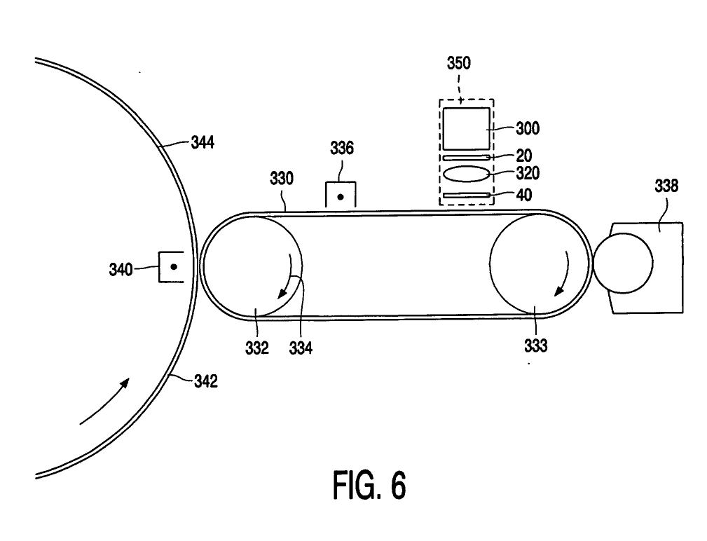

FIG. 6 is a schematic diagram illustrating an embodiment of a printing apparatus wherein the invention can be used.

FIG. 1 shows, very schematically, a conventional proximity printing apparatus for the manufacture of, for example a LCD device. This apparatus comprises a substrate holder 1 for carrying a substrate 3 on which the device is to be manufactured. The substrate is coated with a radiation-sensitive, or resist, layer 5 in which an image, having features corresponding to the device features, is to be formed. The image information is contained in a mask 8 arranged in a mask holder 7. The mask comprises a transparent substrate 9, the lower surface of which is provided with a pattern 10 of transparent and non-transparent strips and areas, which represent the image information. A small air gap 11 having a gap width w of the order of 100 μm separates the pattern 10 from the resist layer 5. The apparatus further comprises a radiation source 12. This source may comprise a lamp 13, for example, a mercury arc lamp, and a reflector 15. This reflector reflects lamp radiation, which is emitted in backward and sideways directions towards the mask. The reflector may be a parabolic reflector and the lamp may be positioned in a focal point of the reflector, so that the radiation beam 17 from the radiation source is substantially a collimated beam. Other or additional optical elements, like one or more lenses, may be arranged in the radiation source to ensure that the beam 17 is substantially collimated. This beam is rather broad and illuminates the whole mask pattern 10 which may have dimensions from 7.5×7.5 cm² to 40×40 cm². For example, illumination step has a duration of the order of 10 seconds. After the mask pattern has been imaged in the resist layer, this is processed in the well-known way, i.e. the layer is developed and etched, so that the optical image is transferred in a surface structure of the substrate layer being processed.

The apparatus of FIG. 1 has a relatively simple construction and is very suitable for imaging in one go a large area mask pattern in the resist layer. However, the photomask is an expensive component and the price of a device manufactured by means of such a mask can be kept reasonably low only if a large number of the same device is manufactured. Mask making is a specialized technology, which is in the hands of a relatively small number of mask manufacturing firms. The time a device manufacturer needs for developing and manufacturing a new device or for modifying an existing device is strongly dependent on delivery times set by the mask manufacturer. Especially in the development phase of a device, when redesigns of the mask are often needed, the mask is a capability-limiting element. This is also the case for low-volume, customer-specific devices.

Direct writing of a pattern in the resist layer, for example by an electron beam writer or a laser beam writer, could provide the required flexibility, but is not a real alternative because this process takes too much time.

Referring to FIG. 1 of the drawings, a known maskless lithography system comprises a substrate holder (not shown) carrying a substrate 3 on which the device is to be made. The substrate 3 is coated with a radiation-sensitive, or resist, layer (not shown) in which an image having features corresponding to the device features is to be formed.

Referring in addition to FIG. 2 of the drawings, an array of ‘light engines 5 is provided, and each light engine 5 comprises a micro shutter (or light valve) 7, comprising, for example, a DMD, LCD, GLV, etc., a projection lens 9, and an individual lens 11. The resultant configuration of the array of light engines 5 is illustrated in FIG. 2 of the drawings. In use, the array of light engines 5 is moved to a first portion of the substrate 3, and the light valves 7 and respective individual lenses 11 create an array of spots 13 in the substrate 3. A first image portion is written into the substrate 3 by selectively switching the light valves 7 on or off in accordance with a predetermined pattern so as to selectively permit or prevent passage of the radiation source 15 to the substrate 3. The array is then moved to another portion of the substrate 3, and the next image portion is written into the substrate 3. This process continues, with movement of the array being both in the length-wise and width-wise direction relative to the substrate, until the complete image pattern has been written into the substrate 3.

However, the optical engines 5 (including the resultant lens array 11) have to be aligned very accurately with respect to each other, otherwise stitching problems may occur, which means that neighbouring sub-fields do not exactly fit together. In general, within lithographic equipment, often high overlay accuracies are required combined with large image fields. Because the optical layout of maskless equipment often results in relatively small image fields, multiple optical systems are combined to get a large image field, as described above with reference to FIGS. 1 and 2. By using multiple light engines, alignment requirements between the engines are difficult to achieve. The lens arrays and optical engines have to be mounted very accurately relative to each other to ensure that there are no gaps between the image fields, resulting in difficulty during manufacture and assembly. Furthermore, the system described above is relatively sensitive to temperature fluctuations, resulting a further reduced overlay performance. Still further, the process of forming optical images using the arrangement described above can be rather time-consuming, particularly where a large surface area is required to be covered.

In order to overcome these problems, and referring to FIGS. 3 and 4 of the drawings, a maskless lithography system according to an exemplary embodiment of the present invention comprises a single unitary element defining a lens array 17 having a length of 1 and a width equal to the width of the substrate 3, instead of an array of individual lenses 11, as in the above-described prior art system. The structure of the optical engines 5 is substantially the same as those of FIG. 1, in that they each comprise a micro-shutter (or light valve) 5, and a projection lens 9. The light valves 5 (also known as picture elements or pixels), are controlled by a computer configuration (not shown) wherein the pattern which is to be configured in a substrate layer is introduced in software. The computer thus determines, at any moment of the writing process and for every light valve, whether it is closed, i.e. blocks the portion of the illuminating beam 15 incident on this light valve, or is open, i.e. transmits this portion to the resist layer.

However, in this case, of course, the lens array for the whole array of optical engines is provided separately, as an imaging element 17 arranged between the row of light valves and the resist layer. This element comprises a transparent substrate and an array of radiation converging elements, as opposed to individual lenses being provided integrally with respective optical engines, as in the prior art, and the array 17 covers the entire width of the substrate 3. It will be apparent that the number of radiation converging elements corresponds to the number of light valves, and the array 17 is aligned with row of light valves so that each converging element belongs to a different one of light valves.

It can be seen that the scanning equipment for moving the system across the substrate 3 can be significantly simplified, relative to the prior art, as it is only required to scan or step in one direction 19, i.e. substantially perpendicular to the row of light valve/converging element pairs. This arrangement also reduces the time it takes to cover the entire substrate 3.

Furthermore, in a system according to the present invention, the optical engines can be positioned relatively inaccurately, because mis-alignment of these elements does not cause significant spot misplacement. The position of the lens array is directly related to the position of the spots (unlike the other optical parts). Thus, by using the present invention, ease of manufacture is improved, and alignment and temperature stability are easier to achieve compared to the prior art. Only one accurate part (the lens array) exists in the system and must be designed to meet requirements. Alignment marks may be provided on the lens array 17 to assist in aligning it with respect to the substrate.

In addition, because a unitary lens array is employed, it can be ‘stretched’ to increase overlay accuracy, and also vibration isolation techniques can be applied only to the lens array, instead of the whole optical system which tends to be more difficult.

In order to ensure correct stitching between the sub-fields of the individual optical engines (for example, each engine may have some overlap with its neighbour), edge-pixels can be shifted by software, as would be apparent to a person skilled in the art. This can be combined with a tilted lens array (or tilted optical engine) approach, if desired. It will be apparent, that although the illustrated exemplary embodiment of the present invention shows the lens array to be provided as a single unitary body, it may comprise two or more lens array modules which are mounted together to create a unitary element, when in use.

An essential parameter for the imaging process is the gap width 44 (FIG. 3). Gap width is one of the input parameters for computing the required power of the refractive lenses and is determined by the required image resolution. If a refractive lens array is computer and manufactured for a given gap width and resolution, this resolution can only be obtained for the given gap width. If, in real circumstances, the gap width deviates from said given gap width, the required resolution cannot be achieved.

The present method is suitable for the manufacture of a device composed of sub-devices, which are positioned at different levels. Such a device may be a purely electronic device or a device that comprises two or more different kinds of features from a diversity of electrical, mechanical or optical systems. An example of such a system is a micro-optical-electrical-mechanical system, known as MOEMS. A more specific example is a device comprising a diode laser or a detector and a light guide and possibly lens means to couple light from the laser into the light guide or from the light guide into the detector. The lens means may be planar diffraction means. For the manufacture of a multilevel device, a substrate is used that has a resist layer deposited on different levels.

In principle, a multiple level device could be manufactured by means of an apparatus having a microlens array, which comprises collections of refractive lenses, which collections differ from each other in that the focal plane of the refractive lenses of each collection is different from that of the other collections. Such an apparatus allows simultaneous printing in different planes of the substrate.

A more practical, and thus preferred method of producing multiple-level devices is to divide software-wise the total image pattern into a number of sub-images each belonging to a different level of the device to be produced. In a first sub-imaging process, a first sub-image is produced, wherein the resist layer is positioned at a first level. The first sub-imaging process is performed according to the, scanning or stepping, method and by the means described hereinbefore. Then the resist layer is positioned at a second level, and in a second sub-imaging process, the sub-image belonging to the second level is produced. The shifting of the resist layer in the Z-direction and the sub-imaging processes are repeated until all sub-images of the multiple-level device are transferred to the resist layer.

The method of the invention can be carried out with a robust apparatus that is, moreover, quite simple as compared with a stepper or step-and-scan lithographic projection apparatus.

In practice, the method of the invention will be applied as one step in a process for manufacturing a device having device features in at least one process layer of a substrate. After the image has been printed in the resist layer on top of the process layer, material is removed from, or added to, areas of the process layer, which areas are delineated by the printed image. These process steps of imaging and removing or adding material are repeated for all process layers until the whole device is finished. In those cases where sub-devices are to be formed at different levels and use can be made of multiple level substrates, sub-image patterns associated with the sub-devices can be imaged with different distances between the imaging element and the resist layer.

The invention can be used for printing patterns of, and thus for the manufacture of display devices like LCD, Plasma Display Panels and PolyLed Displays, printed circuit boards (PCB) and micro multiple function systems (MOEMS).

The invention cannot only be used in a lithographic proximity printing apparatus but also in other kinds of image-forming apparatus, such as a printing apparatus or a copier apparatus.

FIG. 6 shows an embodiment of a printer, which comprises an array of light valves and a corresponding array of refractive lenses according to the invention. The printer comprises a layer 330 of radiation-sensitive material, which serves as an image carrier. The layer 330 is transported by means of two drums, 332 and 333, which are rotated in the direction of arrow 334. Before arriving at the exposure unit 350, the radiation-sensitive material is uniformly charged by a charger 336. The exposure station 350 forms an electrostatic latent image in the material 330. The latent image is converted into a toner image in a developer 338 wherein supplied toner particles attach selectively to the material 330. In a transfer unit 340 the toner image in the material 330 is transferred to a transfer sheet 342, which is transported by a drum 344.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method of forming an optical image in a radiation-sensitive layer, the method comprising the steps of:
providing a radiation source (15);
providing a radiation-sensitive layer (3);
positioning a plurality of individually controlled light valves (7) between the radiation source (15) and the radiation-sensitive layer (3);
positioning a plurality (17) of radiation-converging elements between the plurality of light valves (7) and the radiation-sensitive layer (3), such that each converging element corresponds to a different one of the light valves (7) and serves to converge radiation from the corresponding light valve (7) in a spot area in the radiation-sensitive layer (3); and
simultaneously writing image portions in radiation-sensitive layer areas by scanning said layer (3), on the one hand, and the associated light valve (7) converging element pairs, on the other hand, relative to each other and switching each light valve (7) between an on and off state in dependence upon the image portion to be written by the light valve; the method being characterized in that:
the radiation-converging elements are arranged in side-by-side relation in a single row of length substantially equal to or greater than the width or length of the radiation-sensitive layer (3).

2. A method according to claim 1, wherein said radiation-sensitive layer (3) and said light valve (7) converging elements (17) are scanned relative to each other in a direction substantially perpendicular to the row (17) of converging elements.

3. A method according to claim 1, wherein the converging elements comprise refractive or diffractive lenses, to create a row or array of spots (13) in the radiation-sensitive layer (3).

4. A method according to claim 1, wherein between successive sub-illuminations, the radiation-sensitive layer (3) and the light valve/radiation-converging element rows (7,17) are displaced relative to each other over a distance which is at most equal to the size of the spots (13) formed in the radiation-sensitive layer (3).

5. A method according to claim 3, wherein the intensity of a spot at the border of an image feature may be adapted to the distance between this border feature and a neighbouring feature.

6. A method according to claim 1, wherein the row of light valves (7) is positioned directly to face the row (17) converging elements.

7. A method according to claim 1, wherein the row of light valves (7) may be imaged on the row (17) of converging elements.

8. A method according to claim 1, wherein the row (17) of converging elements is provided for use as a unitary optical element.

9. A method according to claim 8, wherein said unitary optical element (17) comprises a unitary structure having all of the converging elements provided therein.

10. A method according to claim 8, wherein said unitary optical element (17) comprises a support means on which each separate converging element is mounted, for use.

11. A method according to claim 1, forming part of a lithographic process for producing a device in a substrate (3).

12. A method according to claim 11, wherein the radiation-sensitive layer is a resist layer provided on a substrate (3), and the image pattern corresponds to the pattern of features of the device to be produced.

13. A method according to claim 12, wherein the image is divided into sub-images, each belonging to a different level of the device to be produced.

14. A method according to claim 13, wherein during formation of the different sub-images, the resist layer surface is set at different distances from the row (17) of radiation converging elements.

15. A method according to claim 1, forming part of a process for printing a sheet of paper.

16. A method according to claim 15, wherein the radiation-sensitive layer (3) is a layer of electrostatically charged material.

17. Apparatus for carrying out the method according to claim 1, the apparatus comprising:
a radiation source (15);
a radiation-sensitive layer (3);
a plurality of individually controlled light valves (7) positioned between the radiation source (15) and the radiation-sensitive layer (3);
a plurality (17) of radiation-converging elements positioned between the plurality of light valves (7) and the radiation-sensitive layer (3), such that each converging element corresponds to a different one of the light valves (7) and serves to converge radiation from the corresponding light valve in a spot area in the radiation-sensitive layer (3); and
means for simultaneously writing image portions in radiation-sensitive layer areas by scanning said layer (3), on the one hand, and the associated light valve (7) converging element pairs, on the other hand, relative to each other and switching each light valve (7) between an on and off state in dependence upon the image portion to be written by the light valve; the apparatus being characterized in that:
the radiation-converging elements (17) are arranged in side-by-side relation in a single row of length substantially equal to, or greater than, the width or length of the radiation-sensitive layer (3).

18. An optical element (17) comprising a plurality of radiation-converging elements, for use in a method of forming an optical image in a radiation-sensitive layer according to claim 1, the radiation converging elements being arranged in side-by-side relation in a single row (17) substantially equal to or greater than the width or length of the radiation-sensitive layer (3).

19. An image forming element comprising a plurality of individually controlled light valves (7), for use in a method of forming an optical image in a radiation-sensitive layer (3) according to claim 1, the light valves (7) being arranged in side-by-side relation in a single row of length substantially equal to or greater than the width or length of the radiation-sensitive layer (3).

20. A method of manufacturing a device in at least one process layer of a substrate (3), the method comprising the steps of:
forming an image in a resist layer provided on the process layer (3), the image comprising features corresponding to the device features to be configured in the process layer (3); and
removing material from, or adding material to, areas of the process layer (3), which areas are delineated by the image formed in the resist layer, characterized in that the image is formed by means of the method according to claim 1.
